(19) United States
(12) Patent Application Publication
(10) Pub. No.: US 2024/0296755 A1
(43) Pub. Date: Sep. 5, 2024

(54) BRAIN PHANTOM WITH EMBEDDED SENSORS FOR BRAIN INJURY MODELING

(71) Applicant: Virginia Commonwealth University, Richmond, VA (US)

(72) Inventors: Ravi L. Hadimani, Glen Allen, VA (US); Ning Zhang, Glen Allen, VA (US); Lila Schandler, Reston, VA (US); Wesley Lohr, Richmond, VA (US); Parisa Zalmai, Mechanicsville, VA (US); Benjamin Reams, Genoa, IL (US); Anthony Rubio-Tonche, Richmond, VA (US)

(21) Appl. No.: 18/593,023

(22) Filed: Mar. 1, 2024

Related U.S. Application Data
(60) Provisional application No. 63/449,085, filed on Mar. 1, 2023.

(51) Int. Cl. G09B 23/30

(52) U.S. Cl. CPC G09B 23/30

(57) ABSTRACT

Anatomically accurate brain phantoms are physical models of brains which mimic the viscoelastic properties of brain tissues. The material used to represent different layers of the brain may be a composition of a hydrogel solution and a cross-linking agent, with ratios calculated and determined to accurately reflect the brain's mechanical properties, most notably, the viscoelasticity. Embedded sensors (e.g., accelerometers) measure impact forces and shear stresses/strains caused by a concussion-related experimental impact to the phantom. Uses of the hydrogel brain phantom include biomedical research and as a planning tool for medical treatments. A specific subject's brain may be replicated for designing personalized treatment.

### CROSS-REFERENCE TO RELATED APPLICATIONS

This application claims the benefit of U.S. Provisional Patent Application No. 63/449,085, filed Mar. 1, 2023, the complete contents of which are herein incorporated by reference.

### FIELD OF THE INVENTION

The invention generally relates to anatomically accurate brain phantoms and, more particularly, unique brain phantoms, methods of making brain phantoms, and methods of using brain phantoms.

### BACKGROUND

Low-grade traumatic brain injuries or concussions occur every day in a large number of contexts such as but not limited to sports. Large professional and youth sports organizations and medical professionals who treat athletes would benefit from a greater depth in understanding of traumatic brain injuries due to the serious health complications of such injuries. Vehicular accidents are another major source of brain injuries, yet automotive testing currently doesn't use brain phantoms to assess brain injury risks associated with vehicular accidents.

Existing technologies interested in improving understanding of brain injuries have often confined themselves to measuring impacts via a helmet or helmet accessory. For example, U.S. Pat. Nos. 6,826,509B2 and 11,064,752B2 both offer sensors which are worn about the head and collect data at the time the wearer experiences impacts. These solutions are inherently limited to measuring forces which are technically external to the brain, e.g., forces which exist inside a football player's helmet, giving only indirect insights into possible intracranial forces and associated trauma.

Currently, there are no phantoms on the market that allow for a complex understanding of low-grade traumatic brain injuries or concussions. There are no anatomically accurate brain phantoms that mimic the mechanical properties of different brain regions and can measure impact forces and shear stresses/strains in the brain.

There are commercially available brain phantoms like the Basic Adult Brain Phantom from GTSimulators. This phantom is strictly for imaging purposes and cannot record intracranial forces or function outside of being a static brain phantom.

### SUMMARY

According to an aspect of some embodiments, an exemplary brain phantom allows medical professionals to create curated and personalized plans of recovery for a patient's unique brain injury by indicating the exact regions of the brain that experienced injury-level trauma and forces. Furthermore, exemplary devices and techniques of this disclosure will assist researchers in fabricating more effective equipment that protects against traumatic brain injuries (TBIs), mild traumatic brain injuries (mTBIs). concussions, and the like.

An exemplary process for creating a brain phantom may include the production and use of at least two separate dissolvable molds, one for each grey and white matter. The molds may be 3D-printed using high-impact polystyrene (HIPS), which is dissolvable in D-limonene. The two-part molds are filled with a hydrogel calcium chloride mixture layer by layer for placement of sensors such as but not limited to accelerometers. The molds are then allowed to set before being submerged in the solvent, leaving a formed hydrogel phantom after the molds are fully dissolved or sufficiently dissolved for a remainder to be broken away without damaging the phantom.

There is a large amount of variability in concussion data depending not only on the type of impact but also the physiology/anatomy of the person impacted. Accordingly some embodiments entail creating and using brain phantoms tailored to individual persons, e.g., in reliance on medical imaging data (such as MRI data) unique to an individual. Applications for such patient specificity for a given brain phantom may include but are not limited to medical professionals who assist in concussion recovery being enabled able to create custom recovery timelines to each patient based on data collected from a respective brain phantom customized to each patient.

Exemplary phantoms in this disclosure addresses the need for an internal understanding and replication of concussions by mimicking the same material properties of real brain tissue while also having the additional functionality of recording forces within the brain. Embodiments may accordingly offer biofidelic features and data which are absent in today's state of medicine.

The combination of a 3D printable shell using MRI data, and an appropriate hydrogel-to-calcium ratio, allows for multiple regions of the phantoms to be created with their corresponding viscoelastic properties from a single brain scan, leading to testing and studies for medical professionals and research scientists. This also allows for custom phantoms to be made for different patients leading the way for personalized brain phantoms.

An exemplary 3D-printable anatomically accurate brain phantom accurately mimics the mechanical properties of the brain and records forces experienced intracranially. Creating a brain phantom may include determining shape and size for the brain phantom (e.g., the respective shapes/sizes of individual parts/layers of a brain phantom) from medical imaging data of an individual patient so that the brain phantom is personalized to the individual patient. This disclosure allows for the identification of maximum forces and corresponding damage caused in different areas of the brain. An exemplary phantom is able to accurately mimic the response forces real axons undergo during the majority of brain injuries. Such a phantom will also enable more in-depth research and understanding of traumatic brain injuries as well as better treatment plans for TBI patients.

Exemplary embodiments in this disclosure contain embedded sensors inside of anatomically accurate brain phantom for intracranial measurements. In order to create and record useful data on forces experienced intracranially, the brain phantom contains sensors such as accelerometers placed inside of individual lobes of the phantom, for example. An exemplary TBI phantom can be used to measure impact forces/stress in the brain, as opposed to merely around an exterior of the brain, to assess the damage to the brain.

Exemplary methods disclosed herein include embedding of sensors in the hydrogel of a brain phantom as the phantom is being produced. Present phantoms do not include these sensors, forcing concussion-related experiments to be performed using an exterior apparatus attached to the head. The sensor placement provides localized information regarding forces experienced by different portions of the brain internally, including any ricochet caused by the brain hitting the skull.

In some embodiments, this phantom can be utilized to create a database relating forces experienced in the brain to forces measured by sensors in helmets. The results of this research will provide real-time feedback for players who experience traumatic brain injuries in sports regarding the extent of an injury they have experienced without the need for extensive post-injury tests.

An exemplary method of assessing brain injuries may comprise creating a brain phantom based on medical imaging data; subjecting the brain phantom to one or more external forces; and recording acceleration data from one or more sensors embedded in the brain phantom.

An exemplary method of creating a brain phantom may comprise 3D-printing one or more molds from magnetic resonance imaging (MRI) data; filling the one or more molds with a composition of one or more hydrogel precursors mixed with one or more crosslinking agents; placing one or more sensors during the filling step; allowing the one or more molds to set while the composition crosslinks; and removing the one or more molds, leaving the brain phantom with the one or more sensors embedded therein.

Exemplary compositions include but are not limited to a composition consisting of or comprising hydrogel, gelatin, and transglutaminase (TG).

Exemplary embodiments may include brain phantoms (and corresponding methods) which are viscoelastic, including multiple distinguishable parts which are each viscoelastic. Exemplary embodiments may include brain phantoms (and corresponding methods) which are homogenous in structure. Though a phantom may have distinct parts with material properties which differ from one part to another part, the parts are integrally connected and inseparable. This may be accomplished by, for example, curing individual layers of hydrogel while it is in direct contact with another layer of hydrogel which is already cured or simultaneously cured. Sensors may be embedded in a brain phantom without any need to materially alter (in effect damaging) the completed brain phantom at a later point, e.g., by cutting, piercing, or tearing the phantom. An exemplary brain phantom is free of incisions, piercings, tears, and like forms of alteration which may undesirably impact the behavior and properties of the brain phantom in some way.

### BRIEF DESCRIPTION OF THE DRAWINGS

FIG. 1A is a diagram of an exemplary brain phantom incorporated in a system for testing and measuring brain injuries.

FIG. 1B is a cross-section of the exemplary brain phantom of FIG. 1A.

FIG. 2A shows viscoelastic results of a cured composition of hydrogel:gelatin:TG combined at a ratio of 3:3:0.75.

FIG. 2B shows viscoelastic results of a cured composition of hydrogel:gelatin:TG combined at a ratio of 3:3:1.

FIG. 2C shows viscoelastic results of a cured composition of hydrogel:gelatin:TG combined at a ratio of 3:3:2.

FIG. 3 is a plot of viscosity vs. shear rate in logarithmic scale (on both axes) for different compositions of hydrogel-calcium chloride.

FIG. 4 shows a quarter of an exemplary brain phantom mid-production.

FIG. 5 is a process of creating shells/molds from medical imaging data.

FIG. 6 is an exemplary process of creating a brain phantom.

FIG. 7 is a diagram of shells and separate hydrogel mixes which may be used together to form an exemplary brain phantom.

FIG. 8 is a flow diagram depicting a brain phantom at multiple stages of manufacture.

FIG. 9 is another exemplary process for manufacturing a brain phantom according to combined manufacturing techniques of 3D-printing and casting.

FIG. 10 is sample acceleration data from a brain phantom dropped from a height of one foot.

### DETAILED DESCRIPTION

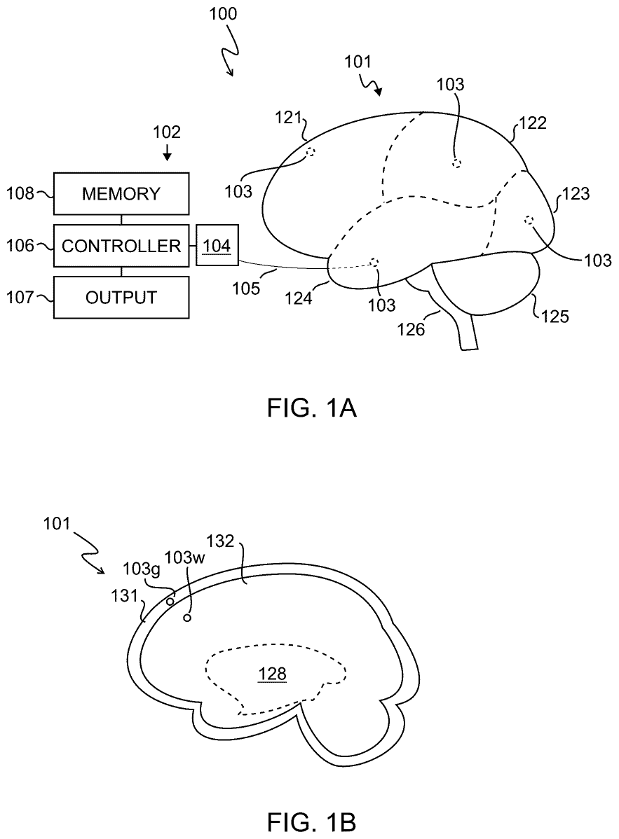

FIG. 1A depicts an exemplary system 100 for assessing brain injuries such as concussion and traumatic brain injury (TBI). The system 100 comprises an exemplary brain phantom 101 and subsystem 102. A brain phantom may model any brain including but not limited to a human brain.

The brain phantom 101 is viscoelastic and comprises at least a first part with a first viscoelasticity and a second part with a second viscoelasticity which differs from the first viscoelasticity. The brain phantom 101 further comprises one or more sensors 103 (e.g., accelerometers) embedded in one or more of the first part and the second part. The brain phantom 101 is shaped and sized to correspond with a biological brain including having different regions which correspond respectively with different biological brain regions. Regions of sensor placement may include one or more of the frontal lobe 121, parietal lobe 122, occipital lobe 123, temporal lobe 124, and cerebellum 125, brainstem 126, and/or other regions not depicted in FIG. 1A (e.g., ventricles or parts generally included in the region 128 of FIG. 1B such as but not limited to the corpus callosum and thalamus).

FIG. 1B depicts further regions or parts of a brain phantom into which sensors may be embedded and which may be configured to have different material properties such as viscoelasticity. FIG. 1B is a cross-section of brain phantom 101 which depicts an outer part 131 representative of grey matter and an inner part 132 representative of white matter. The viscoelasticity of phantom part 131 is configured to match a viscoelasticity of actual biological grey matter, whereas the viscoelasticity of phantom part 132 is configured to match a viscoelasticity of actual biological white matter. By way of example, FIG. 1B shows a sensor 103g embedded in the phantom part 131 and a separate sensor 103w embedded in the phantom part 103w. In this particular scenario, the sensors 103g and 103w are in different parts of the brain with respect to the type of brain tissue (grey or white) but are in the same part of the brain with respect to region. Namely, sensors 103g and 103w are both in the frontal lobe.

FIG. 1A shows in system 100 the exemplary brain phantom 101 connected to a subsystem 102 illustrated in block diagram. The subsystem 102 is configured to receive signals from the one or more sensors 103. A receiver (e.g., receiver module) 104 collects the raw signals from the sensors 103. Sensors 103 may be connected via physical wires, such as wire 105, or by wireless signals. For the latter situation, a sensor 103 may comprise a wireless signal module such as a Bluetooth or WiFi module. The subsystem 102 further comprises a controller 106 (e.g., one or more controllers), one or more outputs 107, and a memory 108. An exemplary controller may be, for example, one or more processors which may include but are not limited to microcontrollers or microprocessors. An exemplary controller for at least some applications may be or include an Arduino Uno. The subsystem 102 may be or include a general purpose computer in some embodiments. Wires 105, if employed, may be for example very thin wires depending on the particular requirements of the chosen sensor to which it must connect, e.g., the size of the contact pads of the sensor. As a non-limiting example, an exemplary brain phantom may use 35-gauge wire. Exemplary wire may be made of, for example, gold or copper. Gold may be preferable over copper in some embodiments because it is more flexible. The wire material may be chosen based on the extent of flexibility required according to the magnitude of forces to which the completed phantom is expected to be subjected.

Different parts (e.g., regions, layers, etc.) of the brain phantom 101 may be configured with different material properties such as viscoelasticity by having different material formulations. An exemplary material for brain phantoms is a hydrogel produced by mixing one or more hydrogel precursor solutions with one or more crosslinking agents (i.e., crosslinkers). Different parts of the brain phantom 101 may have different precursor-to-crosslinker ratios, e.g. different hydrogel-to-calcium ratios, to achieve different viscoelasticities. Calcium chloride (CaCl₂) is an exemplary crosslinking component in a phantom hydrogel composition the amount of which may be varied to vary the viscoelasticity of a part of a brain phantom from some other part of the same brain phantom. An exemplary commercially available hydrogel is CellPhilic™ Physical Crosslinking Hydrogels from Biomaterials USA LLC. In general, an exemplary hydrogel precursor may comprise or consist of Gellan gum, hydrolyzed gelatin, and water. For instance, an exemplary hydrogel precursor may be 0.8 wt % Gellan gum and 0.1 wt % hydrolyzed gelatin in water solution. Exemplary crosslinking agents may include but are not limited to CaCl₂, MgCl₂, and SrCl₂. Other exemplary crosslinkers include transglutaminase (TG) and other protein binding agents.

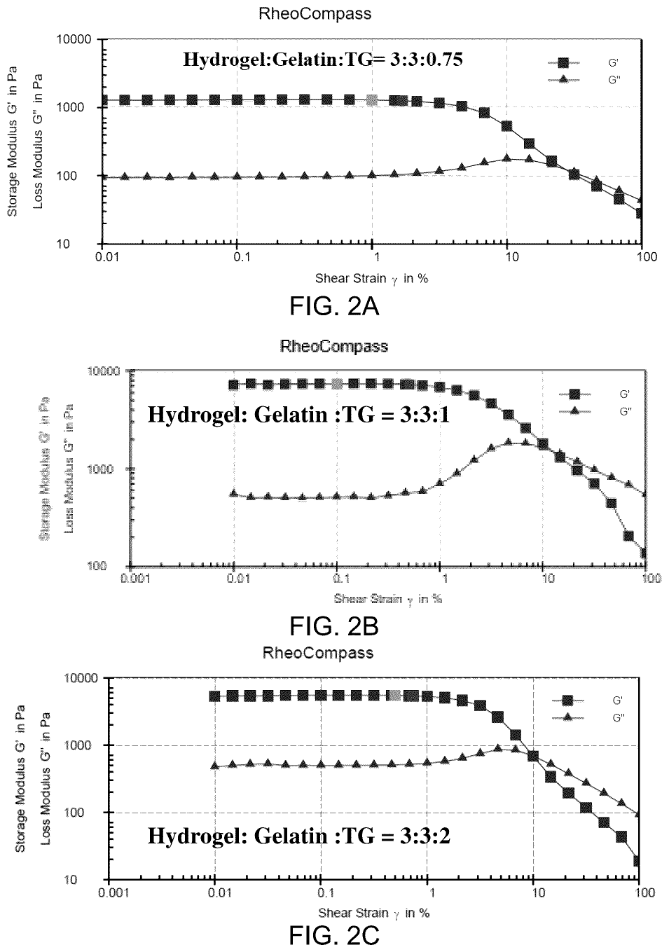

FIGS. 2A, 2B, and 2C depict viscoelastic results of three exemplary compositions for use in making exemplary brain phantoms. The general composition formula consists of hydrogel, gelatin, and transglutaminase (TG). An exemplary brain phantom may be made with these three components. Different parts of the brain phantom are made to have different viscoelastic properties by using different amounts of TG in the respective parts relative to the hydrogel and gelatin. FIG. 2A shows storage modulus G′ (in Pa) and loss modulus G″ (in Pa) of a cured hydrogel:gelatin:TG composition with a ratio of 3:3:0.75 (hydrogel:gelatin:TG). FIG. 2B shows G′ and G″ for a composition with hydrogel:gelatin:TG combined at a ratio of 3:3:1. FIG. 2C shows G′ and G″ for a composition with hydrogel:gelatin:TG combined at a ratio of 3:3:2. A comparison of FIGS. 2A, 2B, and 2C shows how changing the relative amount of the crosslinker, TG, is an effective means for achieving different G′ and G″ for different parts of an exemplary brain phantom.

Exemplary parameters which may be used to characterize the viscoelasticity of exemplary brain phantoms and respective parts thereof include storage modulus G′ and loss modulus G″. Dynamic shear testing on in vitro human brain indicate that the storage modulus G′ for an exemplary human brain may lie between 6-11×10³ dyn/cm², and the loss modulus G″ may lie between 3.5-6.0×10³ dyn/cm². Accordingly, an exemplary brain phantom modeling a brain such as a human brain may be configured to have a G′ for the phantom as a whole (e.g., averaged value) or for a particular part thereof with a lower limit of, e.g., 0.4, 0.5, 0.6, 0.7, 0.8, 0.9, 1.0, or 1.1 kPa. The brain phantom may be configured to have a G′ for the phantom as a whole (e.g., averaged value) or for a particular part thereof with an upper limit of, e.g., 1.1, 1.2, 1.3, 1.4, 1.5, 1.6, 1.7, 1.8, 1.9, 2.0, 2.1, 2.2, 2.3, 2.4, or 2.5 kPa. A phantom or a particular part of such phantom may be configured to have a G′ limited to a range formed by any one of the preceding exemplary lower limits and any one of the preceding exemplary upper limits (e.g., a range of 0.4 to 2.5 kPa). An exemplary brain phantom modeling a brain such as a human brain may be configured to have a G″ for the phantom as a whole (e.g., averaged value) or for a particular part thereof with a lower limit of, for example, 0.05, 0.1, 0.2, 0.3, 0.35, 0.4, 0.5, or 0.6 kPa. The brain phantom may be configured to have a G″ for the phantom as a whole (e.g., averaged value) or for a particular part thereof with an upper limit of, e.g., 0.4, 0.5, 0.6, 0.7, 0.8, 0.9, or 1.0 kPa. A phantom or a particular part of such phantom may be configured to have a G″ limited to a range formed by any one of the preceding exemplary lower limits and any one of the preceding exemplary upper limits (e.g., a range of 0.05 to 1.0 kPa). An exemplary process of making a brain phantom may include a step of determining G′ and/or G″ for the phantom as a whole and/or for individual parts of the phantom. This determination may include measuring the material properties of actual brain tissue, e.g., by a rheometer and/or by magnetic resonance elastography (MRE).

Exemplary brain phantoms may have parameters such as but not limited to one or more of the following: an elastic modulus of 1.1-1.8 kPa or 1.4-1.55 kPa; a bulk modulus of 1.5-3.0 GPa or 1.9-2.15 GPa; a viscosity of 0.3-1.0 kPa or 0.4-0.55 kPa; a dura elastic modulus of 50-90 MPa or 62-74 MPa; and a total mass of 1000-1500 g or 1200-1400 g.

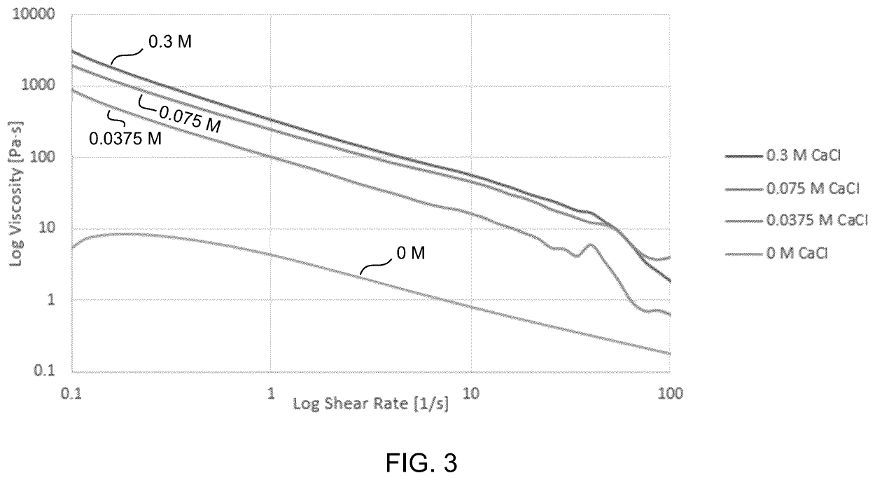

FIG. 3 shows the viscosity measurement vs. shear rate in logarithmic scale of different compositions of hydrogel-calcium chloride. Different loading percentage of CaCl allows for tuning the viscosity of the hydrogel to match the viscosity of grey matter and white matter, for example.

Exemplary hydrogel compositions are tunable to match the viscosity of different parts of a biological brain at both static and different shear rates. A brain phantom's viscoelasticity may tested using a rheometer to ensure accuracy of representation of the viscoelastic properties of the brain (e.g., human brain).

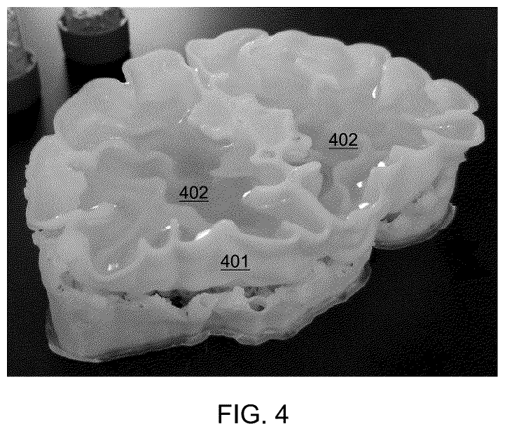

FIG. 4 shows a quarter of an exemplary brain phantom mid-production. A 3D-printed mold 401 made of HIPS filament models the surface of grey matter. A transparent hydrogel composition 402 (which may be crosslinked with, e.g., calcium chloride) is retained by the mold until it is cured. Further negative molds may be inserted into the hydrogel composition prior to curing for adding additional parts to the phantom, a process explained in greater detail below.

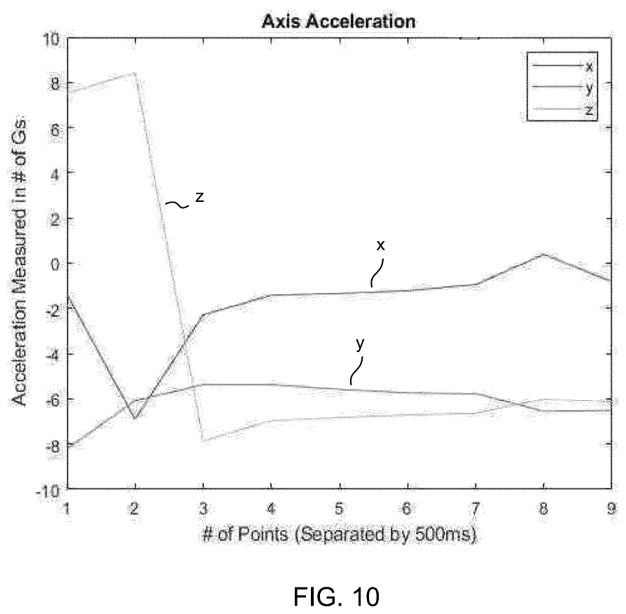

Exemplary sensors embedded in brain phantoms according to this disclosure may be configured to collect at least acceleration data. The sensors may be configured to collect and help record useful data on forces experienced intracranially. It should be understood that a brain phantom may be paired with a physical component modeled after a human skull, or not, depending on the use case. Whether or not a model skull is used, collecting data from within the brain phantom may in any case be referred to as collecting data “intracranially”. For illustrative purposes, FIG. 10 depicts actual axis acceleration data collected from an embedded three-axis accelerometer in an exemplary brain phantom when the phantom was dropped from a height of one foot.

Customized brain phantoms (e.g., a brain phantom made to the MRI data of a single patient) may be made economically by, for example, making use of inexpensive commercially available components. All components of the microcontroller and accelerometer interface may be selected for economy. For instance, an exemplary accelerometer available commercially at the time of writing of this disclosure is a 3-axis accelerometer such as but not limited to the 3-axis ADXL372 accelerometers from Analog Devices. The Arduino Uno runs C++ code published publicly by Analog Devices specifically for producing data from the ADXL372 accelerometer. The Arduino Uno is widely available for under $30 at the time of this disclosure, and the ADXL372 accelerometers are under $20 each. Assembling the circuitry and compiling the freely available code is inexpensive and doesn't need any licenses. Other phantoms on the market are fully assembled but can be expensive and lack any sort of intracranial force measurement system. While more advanced computers may be used for the subsystem 102 of FIG. 1A, a simple microcontroller setup may be desired in some implementations to allow researchers to create an inexpensive measurement system for exemplary brain phantoms.

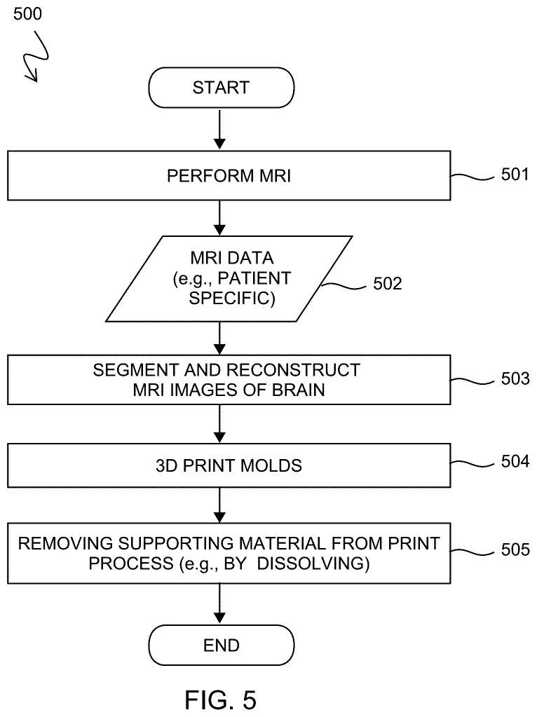

FIG. 5 is an exemplary process 500 for manufacturing molds to be used in creating a brain phantom. A high level of anatomical correctness may be achieved by using medical imaging data such as magnetic resonance imaging (MRI) data from an actual human head and brain as the basis for what the phantom should mimic. Accordingly, at block 501 an MRI procedure is performed to generate MRI data 502. Because some of the manufacturing approaches described herein are especially cost effective, it may be that different phantoms are made for different respective patients. Patient specific MRI data may be used in each case for producing the phantom. Alternatively, a particular phantom template may be used for understanding concussions and other brain injuries more generally, generating information useful and desirable for treating a variety of patients or for educational purposes such as in medical schools.

At block 503 the MRI brain images are segmented and reconstructed using computer program tools. MRI data may have .nii file extensions, for example, and require conversion for 3D modeling prior to supplying the data to a 3D printer. Software suitable for block 503 at the time includes but is not limited to FreeSurfer, FSL, and simNIBS. The output of such programs may be imported to another program (e.g., Meshmixer) to actually make the molds (sometimes referred to in the alternative as “shells” in this disclosure).

At block 504 molds are actually manufactured in a tangible form. 3D printing is an exemplary means for producing the molds in a cost-effective manner. Exemplary materials for the 3D printing process include an ABS (acrylonitrile butadiene styrene) material and high impact polystyrene (HIPS). 3D printing may require the printing of supporting structures which do not actually have any anatomical analog. In such a case, these supporting structures may be removed by, for example, chemically dissolving the parts (e.g., with acetone for ABS or D-limonene for HIPS) at block 505. The total number of molds required for making a single brain phantom may vary among embodiments. Discussed below in connection with further figures is an exemplary scenario involving four molds. It should be appreciated, however, that some embodiments may entail two, three, four, five, six, seven, eight, nine, ten, or some other number of molds.

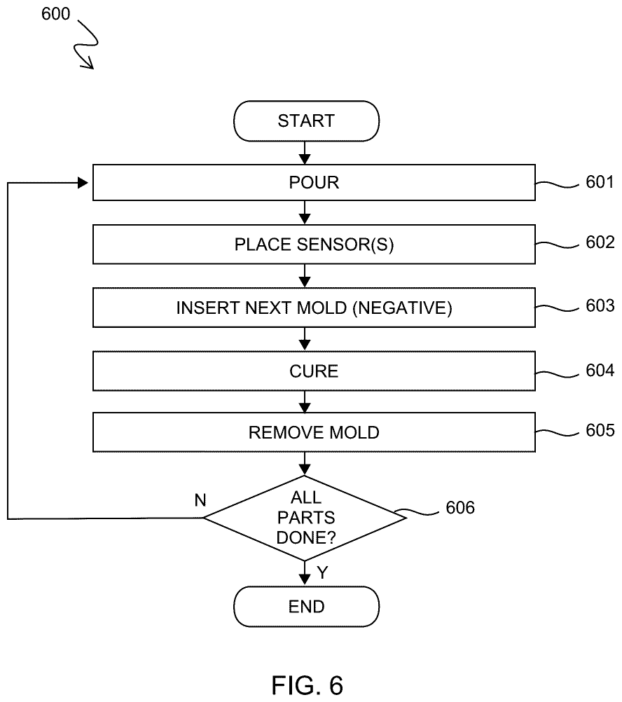

FIGS. 6, 7, and 8 are coordinated with one another to illustrate an exemplary process of creating a brain phantom. As a brief opening summary, FIG. 6 portrays in flowchart format an exemplary process 600 of creating a brain phantom. The process 600 involves repeated cycles of pouring of a hydrogel precursor solution mixed with crosslinking agent (block 601) and curing (block 604). In general, a separate cycle is performed for each separate part of the brain phantom which is to have one or more properties (e.g., viscoelasticity parameter/s) distinct from other parts of the brain phantom. The type of curing may vary among embodiments depending on the crosslinking agent/s used in a given embodiment. In some embodiments, curing may entail simply waiting (e.g., at ambient temperature) a predetermined period of time which begins accruing from the time hydrogel precursor solution is mixed with the crosslinking agent/s. Alternatively, embodiments may entail curing by exposure to a predetermined temperature (e.g., a temperature which is higher than ambient room temperature) or by other mechanisms of curing hydrogels which are known in the art.

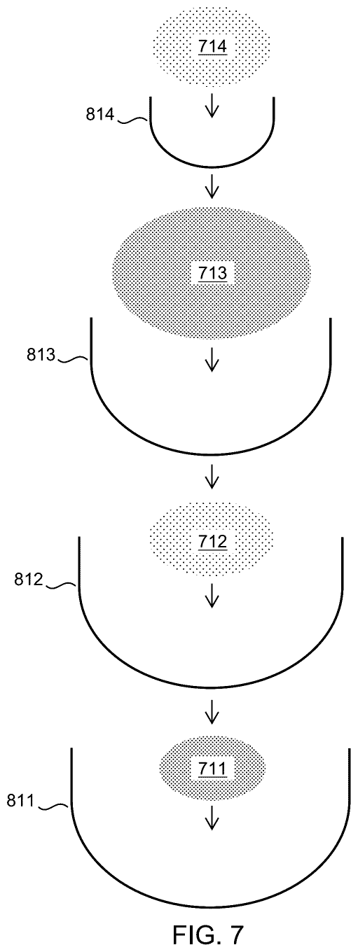

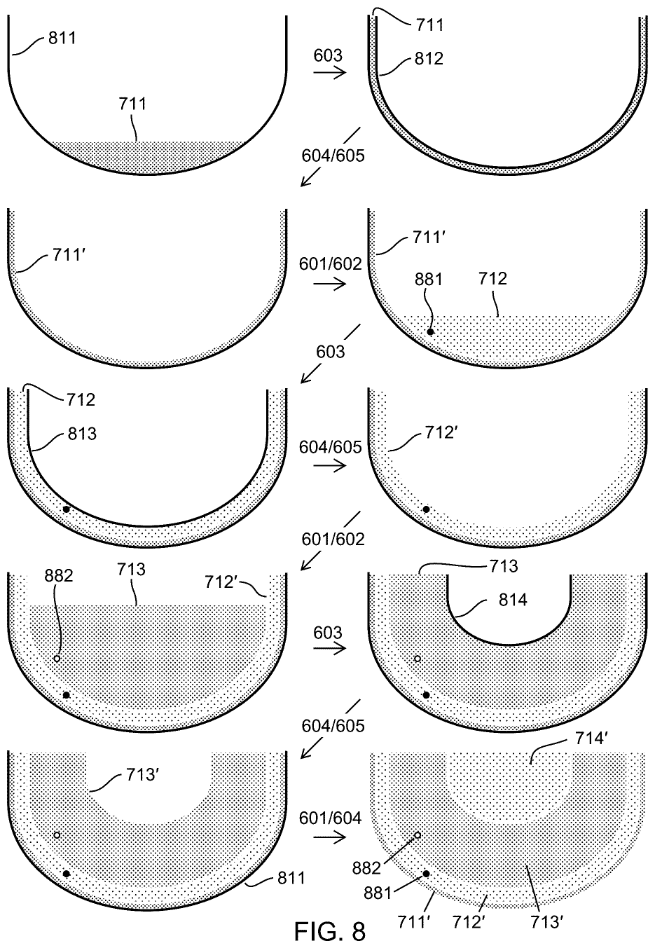

The pouring step 601 is made into a mold or else into a partially formed brain phantom (in which case uncured hydrogel solution may be retained by an already cured region/part/layer of the brain phantom). Depending on the stage of production for a given cycle and on the desired placement of sensors, each cycle may or may not include steps of placing one or more sensors (block 602), inserting a “negative” mold (block 603), and removing the negative mold (block 605). Especially in light of the delicate and intricate shapes of different layers/regions of the brain, removal of a mold may be achieved by dissolution with a solvent that does not react with or affect hydrogel. Variation among the cycles is made clearer by FIGS. 7 and 8.

FIG. 7 is a diagram of molds (i.e., shells) and separate compositions which may be used together to form an exemplary brain phantom. The quantity of molds for any given embodiment may vary according to the total number of separate parts, regions, or layers desired in the completed phantom. For this particular example, FIG. 7 illustrates materials for producing a brain phantom that has four parts each with a different respective viscoelasticity. FIG. 7 depicts a first mold 811, second mold 812, third mold 813, and fourth mold 814. In this example, the interior surface of mold 811 models the dura of a biological brain. The exterior surface of mold 811 need not model anything in particular and may be shaped simply to allow the mold to sit stably on a flat surface such as a table, platform, or manufacturing belt. The composition 711 is configured so that, once cured, it has a viscoelasticity which corresponds (e.g., matches within a margin of error) with biological dura. The surfaces of mold 812 model the shape of the interface between dura and grey matter. The composition 712 is configured so that, once cured, it has a viscoelasticity which corresponds (e.g., matches within a margin of error) with biological grey matter. The surfaces of mold 813 model the shape of the interface between grey matter and white matter. The composition 713 is configured so that, once cured, it has a viscoelasticity which corresponds (e.g., matches within a margin of error) with biological white matter. The surfaces of mold 814 model the shape of the interface between white matter and ventricles. The composition 714 is configured so that, once cured, it has a viscoelasticity which corresponds (e.g., matches within a margin of error) with filled biological ventricle(s).

FIG. 8 is a flow diagram which pulls together the steps of exemplary process 600 with the physical items summarized by FIG. 7. As the arrows in FIG. 8 indicate, the manufacturing process proceeds from left to right, top to bottom. Composition 711 is poured into mold 811, arriving at the illustration of the first column, first row. Next negative mold 812 is inserted in the pooled composition 711 before it cures, distributing composition 711 into the shape of dura, as depicted by the illustration of the second column, first row. The composition 711 is cured into cured hydrogel 711′, and then mold 812 is removed, arriving at the illustration of the first column, second row. Next composition 712 is poured directly onto cured hydrogel 711′. In addition, a sensor 881 is placed within the composition 712, as depicted by the illustration of the second column, second row. (Negative) mold 813 is inserted into the composition 712 to distribute composition 712 into the anatomically accurate shape of grey matter, arriving at the illustration of the first column, third row. The composition 712 is cured into cured hydrogel 712′, and then mold 813 is removed, arriving at the illustration of the second column, third row. Next composition 713 is poured directly onto cured hydrogel 712′. In addition, a sensor 882 is placed within the composition 713, as depicted by the illustration of the first column, fourth row. (Negative) mold 814 is inserted into the composition 713 to displace and distribute composition 713 into the anatomically accurate shape of white matter, arriving at the illustration of the second column, fourth row. The composition 713 is cured into cured hydrogel 713′, and then mold 814 is removed, arriving at the illustration of the first column, fifth row. Next composition 714 is poured directly into cured hydrogel 713′ and cured into cured hydrogel 714′. The outermost mold 811 may be left in place throughout the preceding steps to provide a rigid support for the phantom as it is assembled part by part. After all the hydrogel compositions are poured and cured, the mold 811 is then removed, leading to the completed brain phantom illustrated in the second column, fifth row.

FIG. 8 is but one non-limiting example of a process of creating a brain phantom. More sensors like 881 and 882 may be placed wherever desired throughout the brain phantom. In some situations, it may be desired to produce a brain phantom which has no sensors embedded therein. The number of parts in a completed brain phantom may vary among embodiments as well. For instance, some embodiments may omit a dura layer, ventricles, or both dura and ventricles. Still other variations include having one or more additional parts/structures than the exemplary options of dura, grey matter, white matter, and ventricles.

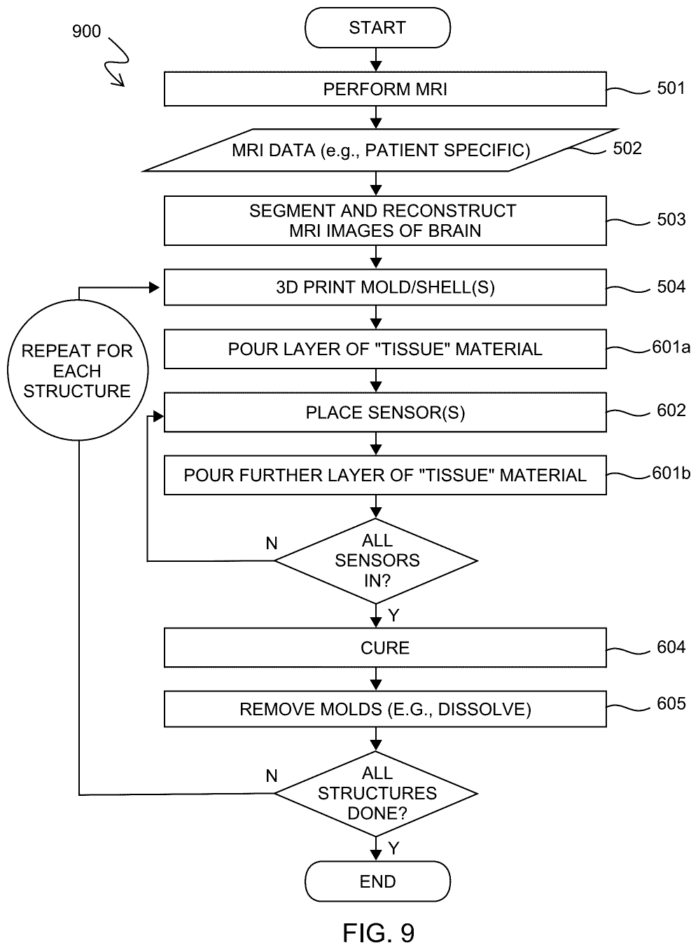

By way of example, FIG. 9 is an alternative exemplary process 900 for manufacturing molds to be used in creating a brain phantom according to combined manufacturing techniques of 3D-printing and casting. FIG. 9 presents an alternative sequence to steps introduced above in connection with FIGS. 5 and 6. In FIG. 9, a layer of the “tissue” material composition is poured between shells (e.g., between and upper and lower shell pair, and/or between an inner and outer shell pair) at block 601a. One or more sensors are placed at block 602, then a further layer of uncured material is poured at block 601b. In this way sensors may be embedded in the brain phantom without any need to materially alter (in effect damaging) the completed brain phantom at a later point, e.g., by cutting, piercing, or tearing the phantom. An exemplary brain phantom is free of incisions, piercings, tears, and like forms of alteration which may undesirably impact the behavior and properties of the brain phantom in some way. Depending on the number and desired positions of sensors for a given brain phantom, the process 900 may entail pouring more than just two layers of “tissue” material. The brain phantom is permitted to cure at block 604. An exemplary curing process may involve time during which the chemical composition of the “tissue” material reacts and sets. The curing process may involve exposing the “tissue” material to some form of electromagnetic radiation that triggers curing or just keeping the material at environmental conditions for a finite duration of time.

After the conductive “tissue” material cures, the shells and the conductive material are placed in an appropriate chemical bath (e.g., acetone or D-limonene) to dissolve all remaining shell material (e.g., ABS or HIPS) at block 605, leaving only the cast “tissue” material with embedded sensor(s) for the phantom behind. The mold-making and casting may be repeated for further parts, depending on the desired complexity and purpose for which the brain phantom will be used. For some tissue structures a prior casting may be used in place of one or more shells, as discussed above, e.g., see FIG. 8. As a result some tissue structures of the phantom are produced using two or more shells, some with only one shell, and some without any shells. Advantages of this approach are many. Fewer shells means less 3D printing which means lower costs of production. Using a prior casting of an existing part as the “mold” for the next part also means the two tissues will intimately share a boundary and reduce or avoid the possibility of gaps between phantom layers which could negatively affect the behavior across the material-to-material boundary. At the conclusion of process 900 all shells have been removed and a multi-layered brain phantom remains and is ready for use.

U.S. Pat. No. 11,373,552 describes some brain phantom production techniques which may be employed in connection with some embodiments of the present disclosure. U.S. Pat. No. 11,373,552, issued Jun. 28, 2022, is incorporated herein by reference.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Where a range of values is provided in this disclosure, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless otherwise noted, the terms “a” or “an,” as used in the specification and claims, are to be construed as meaning “at least one of.” In addition, this statement is intended to serve as antecedent basis for use of such exclusive terminology as “solely”, “only”, and the like in connection with the recitation of claim elements, or use of a “negative” limitation. In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

Some embodiments of the present invention may be a system, a device, a method, and/or a computer program product. A system, device, or computer program product may include a computer readable storage medium (or media) having computer readable program instructions thereon for causing a processor to carry out aspects of the present invention, e.g., processes or parts of processes or a combination of processes described herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Processes described herein, or steps thereof, may be embodied in computer readable program instructions which may be paired with or downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions and in various combinations.

These computer readable program instructions may be provided to one or more processors of one or more general purpose computers, special purpose computers, or other programmable data processing apparatuses to produce a machine or system, such that the instructions, which execute via the processor(s) of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While exemplary embodiments of the present invention have been disclosed herein, one skilled in the art will recognize that various changes and modifications may be made without departing from the scope of the invention as defined by the following claims.

What is claimed is:

1. A brain phantom, comprising
a first part with a first viscoelasticity; and
a second part with a second viscoelasticity which differs from the first viscoelasticity;
wherein the brain phantom is shaped and sized to correspond with a biological brain including having different parts which correspond respectively with different biological brain regions.

2. The brain phantom of claim 1, wherein the first viscoelasticity matches a viscoelasticity of grey matter, wherein the second viscoelasticity matches a viscoelasticity of white matter.

3. The brain phantom of claim 1, further comprising one or more sensors embedded in one or more of the first part and the second part, wherein the one or more sensors are configured to collect at least acceleration data.

4. The brain phantom of claim 1, wherein the first part and second part have different hydrogel precursor-to-crosslinking agent ratios.

5. The brain phantom of claim 1, wherein the first and second parts of the brain phantom comprise at least a first region and a second region which is different from the first region, wherein the one or more sensors comprise at least a first accelerometer embedded in the first region of the brain phantom and a second accelerometer embedded in the second region of the brain phantom.

6. The brain phantom of claim 1, wherein the brain phantom is free of incisions, piercings, and tears.

7. The brain phantom of claim 1, wherein the brain phantom is shaped and sized to correspond with the biological brain of an individual patient so that the brain phantom is personalized to the individual patient.

8. The brain phantom of claim 1, wherein the first part and the second part each comprise hydrogel, gelatin, and transglutaminase (TG), wherein the first part has a different ratio of hydrogel:gelatin:TG than does the second part.

9. A system for assessing brain injuries, comprising
the brain phantom of claim 3; and
a controller configured to collect measurements made by the one or more sensors.

10. The system of claim 9, wherein the first viscoelasticity matches a viscoelasticity of grey matter, wherein the second viscoelasticity matches a viscoelasticity of white matter.

11. A method of assessing brain injuries, comprising
creating a brain phantom, wherein the brain phantom comprises a first part with a first viscoelasticity and a second part with a second viscoelasticity which differs from the first viscoelasticity, wherein the brain phantom is shaped and sized to correspond with a biological brain including having different parts which correspond respectively with different biological brain regions;
subjecting the brain phantom to one or more external forces; and
recording acceleration data from one or more sensors embedded in the brain phantom.

12. The method of claim 11, wherein the first viscoelasticity matches a viscoelasticity of grey matter, wherein the second viscoelasticity matches a viscoelasticity of white matter.

13. The method of claim 11, wherein the creating step includes determining shape and size for the brain phantom from medical imaging data of an individual patient so that the brain phantom is personalized to the individual patient.

14. The method of claim 11, wherein the creating step comprises
3D-printing one or more molds from medical imaging data;
filling the one or more molds with one or more compositions comprising one or more hydrogel precursor solutions and one or more crosslinking agents;
placing one or more sensors during the filling step;
allowing the one or more molds to set while the one or more compositions crosslink; and
removing the one or more molds, leaving the brain phantom with the one or more sensors embedded therein.

15. The method of claim 14, wherein the creating step further comprises selecting a first hydrogel-to-calcium ratio for at least one of the one or more compositions such that after crosslinking the brain phantom has the first viscoelasticity in the first part.

16. The method of claim 15, wherein the creating step further comprises selecting a second hydrogel-to-calcium ratio for another of the one or more compositions such that after crosslinking the brain phantom has the second viscoelasticity in the second part.

17. The method of claim 11, wherein the removing step comprises dissolving the one or more molds.

18. A method of creating a brain phantom, comprising
3D-printing one or more molds from medical imaging data;
filling the one or more molds with one or more compositions comprising one or more hydrogel precursor solutions and one or more crosslinking agents;
placing one or more sensors during the filling step;
allowing the one or more molds to set while the one or more compositions crosslink; and
removing the one or more molds, leaving the brain phantom with the one or more sensors embedded therein.

19. The method of claim 18, wherein the creating step further comprises selecting a first hydrogel-to-calcium ratio for at least one of the one or more compositions such that after crosslinking the brain phantom has a predetermined first viscoelasticity in a first part.

20. The method of claim 19, wherein the creating step further comprises selecting a second hydrogel-to-calcium ratio for another of the one or more compositions such that after crosslinking the brain phantom has a predetermined second viscoelasticity in a second part, wherein the second viscoelasticity differs from the first viscoelasticity.

21. The method of claim 20, wherein the first viscoelasticity matches a viscoelasticity of grey matter, wherein the second viscoelasticity matches a viscoelasticity of white matter.

22. The method of claim 18, wherein the removing step comprises dissolving the one or more molds.
